(19) United States
(12) Patent Application Publication
(10) Pub. No.: US 2024/0391640 A1
(43) Pub. Date: Nov. 28, 2024

(54) Barrier Member For Container, Related Containers, Systems, And Methods

(71) Applicant: Graphic Packaging International, LLC, Atlanta, GA (US)

(72) Inventor: Nils Lagerwall, Genarp (SE)

(21) Appl. No.: 18/669,741

(22) Filed: May 21, 2024

Related U.S. Application Data
(60) Provisional application No. 63/468,113, filed on May 22, 2023.

(51) Int. Cl. B65D 5/56; B31B 50/25; B31B 50/66; B31B 105/00; B31B 120/10; B31B 120/40; B32B 27/08; B32B 27/10; B32B 27/30; B32B 27/32; B32B 27/36; B65D 5/12; B65D 5/40; B65D 5/54

(52) U.S. Cl. CPC B65D 5/563; B31B 50/252; B31B 50/66; B32B 27/08; B32B 27/10; B32B 27/306; B32B 27/32; B32B 27/36; B65D 5/12; B65D 5/40; B65D 5/5405; B31B 2105/001; B31B 2120/102; B31B 2120/40; B32B 2307/518; B32B 2307/72; B32B 2307/7376; B32B 2439/62

(57) ABSTRACT

A container for holding at least one article includes a body extending at least partially around an interior of the container, a closed top engaged with the body, a closed bottom engaged with the body, and a barrier member positioned in the interior of the container, the barrier member comprising a laminate structure that includes at least one polymeric layer with an uninterrupted lower portion.

### CROSS-REFERENCE TO RELATED APPLICATION

The present application claims the benefit of U.S. Provisional Patent Application No. 63/468,113, filed on May 22, 2023.

### INCORPORATION BY REFERENCE

The disclosure of U.S. Provisional Patent Application No. 63/468,113, filed on May 22, 2023, is hereby incorporated by reference for all purposes as if set forth in its entirety.

### BACKGROUND

The present disclosure generally relates to containers for holding one or more articles. In some embodiments, the present disclosure relates to containers having at least one barrier member.

### SUMMARY

According to one aspect, the disclosure is generally directed to a container for holding at least one article, the container comprising a body extending at least partially around an interior of the container, a closed top engaged with the body, a closed bottom engaged with the body, and a barrier member positioned in the interior of the container, the barrier member comprising a laminate structure that includes at least one polymeric layer with an uninterrupted lower portion.

According to another aspect, the disclosure is generally directed to a combination of blanks for forming a container for holding at least one article, the combination of blanks comprising a body blank for forming a body of the container formed from the combination of blanks, a bottom blank for being engaged with the body of the container formed form the combination of blanks to form a closed bottom, a lid blank for engaging the body of the container formed from the combination of blanks to form a closed top, and a barrier blank for forming a barrier member of the container formed from the combination of blanks, the barrier blank comprising a laminate structure that includes at least one polymeric layer with an uninterrupted lower portion.

According to another aspect, the disclosure is generally directed to a method of forming a container for holding at least one article, the method comprising obtaining a body blank, obtaining a bottom blank, obtaining a lid blank, obtaining a barrier blank, the barrier blank comprising a laminate structure that includes at least one polymeric layer with an uninterrupted lower portion, positioning the body blank to form a body extending at least partially around an interior of the container, engaging the bottom blank with the body of the container to form a closed bottom of the container, engaging the barrier blank with the body of the container to form a barrier member in the container, and engaging the lid blank with the body of the container to form a closed top of the container.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a body blank used to form a body of a container according to an exemplary embodiment of the disclosure.

FIG. 2 is a plan view of an exterior surface of a lid blank for forming a lid or top end of a container according to an exemplary embodiment of the disclosure.

FIG. 3 is a plan view of an exterior surface of a bottom blank for forming a bottom of a container according to an exemplary embodiment of the disclosure.

FIG. 4A is a plan view of an exterior surface of a barrier blank for forming a barrier member of a container according to an exemplary embodiment of the disclosure.

FIG. 4B is a plan view of the interior surface of the barrier blank of FIG. 4A.

FIG. 5A is a cross-sectional view of an exemplary embodiment of a laminate structure that can form the barrier blank of FIGS. 4A and 4B.

FIG. 5B is a cross-sectional view of an alternative exemplary embodiment of a laminate structure that can form the barrier blank of FIGS. 4A and 4B.

FIG. 5C is a cross-sectional view of another alternative exemplary embodiment of a laminate structure that can form the barrier blank of FIGS. 4A and 4B.

FIG. 5D is a cross-sectional view of another alternative exemplary embodiment of a laminate structure that can form the barrier blank of FIGS. 4A and 4B.

FIG. 5E is a cross-sectional view of another alternative exemplary embodiment of a laminate structure that can form the barrier blank of FIGS. 4A and 4B.

FIG. 5F is a cross-sectional view of another alternative exemplary embodiment of a laminate structure that can form the barrier blank of FIGS. 4A and 4B.

FIG. 6A is a first sequential perspective view of a formation of a container from the blanks of FIGS. 1-4B according to an exemplary embodiment of the disclosure.

FIG. 6B is a second sequential perspective view of a formation of a container from the blanks of FIGS. 1-4B according to an exemplary embodiment of the disclosure.

FIG. 6C is a third sequential perspective view of a formation of a container from the blanks of FIGS. 1-4B according to an exemplary embodiment of the disclosure.

FIG. 6D is a fourth sequential perspective view of a formation of a container from the blanks of FIGS. 1-4B according to an exemplary embodiment of the disclosure.

Corresponding parts are designated by corresponding reference numbers throughout the drawings.

### DETAILED DESCRIPTION

Containers according to the present disclosure can accommodate articles of numerous different shapes. For the purpose of illustration and not for the purpose of limiting the scope of the disclosure, the following detailed description describes articles such as food products. Such food products can be provided in discrete or granular portions, e.g., as in snacks, for example, candy, gum, chocolate, granola, cereal, nuts, trail mix, raisins, dried fruit, etc. It will be understood that a different type of article such as a different type of food product or different type of article, e.g., powdered food products or powdered articles, can be held in containers according to the present disclosure without departing from the disclosure. For example, powered products/articles can include nutritional supplements such as baby or infant formula, adult nutritional supplements, other dehydrated food products for being reconstituted with water or other fluids, etc. It will be further understood that articles other than food products can be held in containers according to the present disclosure.

In this specification, the terms “lower,” “bottom,” “upper,” and “top” indicate orientations determined in relation to fully erected and upright containers. As described herein, containers can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

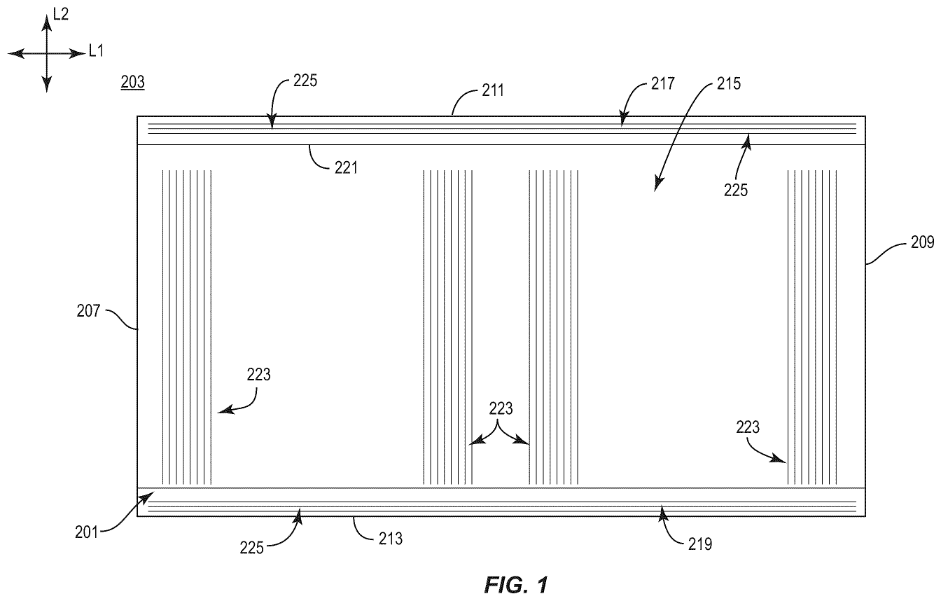

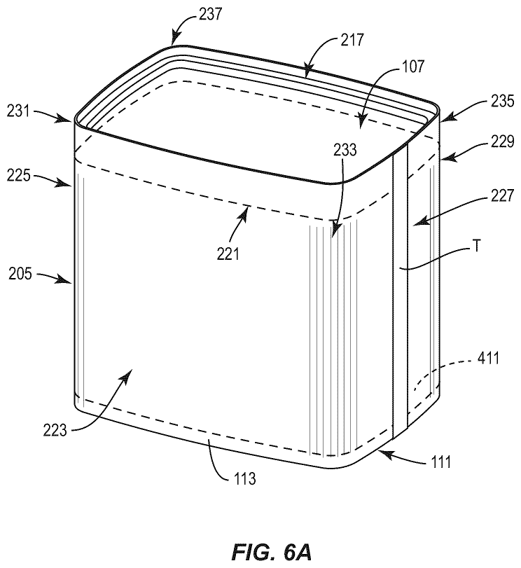

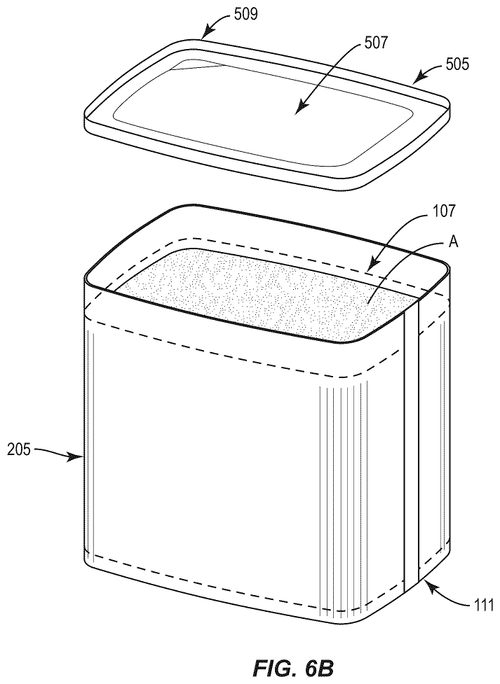

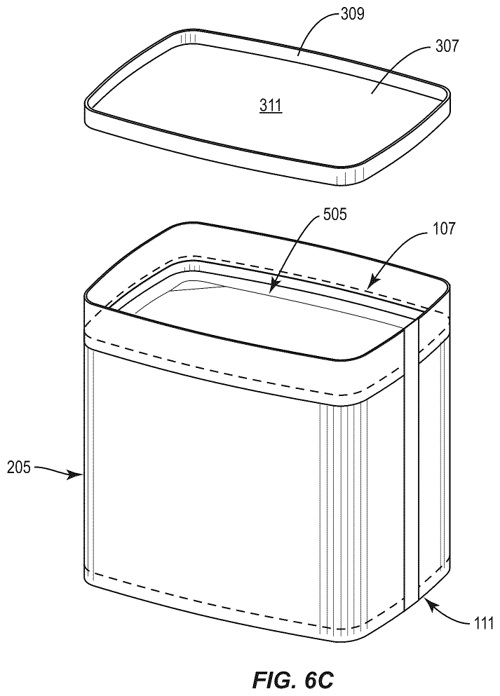

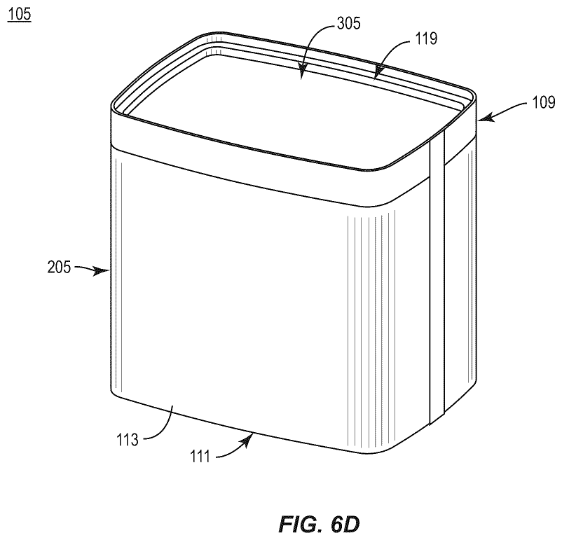

FIGS. 1-4B are plan views of a series of blanks used to form components that assemble to form a container 105 (FIG. 6D) according to an exemplary embodiment of the present disclosure. In this regard, in some embodiment the container 105 can be considered an assembly or system of a plurality of components.

Referring to FIG. 1, a plan view of an exterior surface 201 of a body blank 203 for forming a body 205 of the container 105 is illustrated. As described herein, the body 205 is arranged to extend at least partially around an interior 107 of the container 105.

As shown, the body blank 203 can have a longitudinal axis L1 and a lateral axis L2. In some embodiments, the axes L1, L2 can be transposed. In the illustrated embodiment, the body blank 203 can have a generally rectangular configuration with a pair of opposite lateral free edges 207, 209 and a pair of opposite longitudinal free edges 211, 213 extending from a respective endpoint of the free edge 207 to a respective endpoint of the free edge 209.

The body blank 203 can also include a body forming portion 215 defined along a central portion of the body blank 203, a first or top end or lid forming portion 217 defined at an upper peripheral portion/upper marginal portion of the body blank 203, and a second or bottom end forming portion 219 defined at a lower peripheral portion/lower marginal portion of the body blank 203.

As shown, the lid forming portion 217 of the body blank 203 can be at least partially separably connected to the body forming portion 215 and at least partially foldably connected to the body forming portion 215 at a longitudinal line of weakening 221 that can include at least one tear segment and at least one fold line segment.

In some embodiments, the bottom end forming portion 219 of the body blank 203 can be at least partially separably and/or foldably connected to the body forming portion 215 thereof at a longitudinal line of weakening 224 that include one or more of tear segments and fold line segments.

With continued reference to FIG. 1, the body blank 203 can include a multiple pluralities of lateral lines of weakening 223 that can facilitate the formation of curved corners when the body 205 is formed from the body blank 203, as described further herein.

The body blank 203 can also include one or more pluralities of longitudinal lines of weakening 225 extending therealong. In the illustrated embodiment, the body blank 203 can include a plurality of longitudinal lines of weakening 225 extending across the lid forming portion 217 and another plurality of longitudinal lines of weakening 225 extending along the body forming portion 219. As described further herein, the lines of weakening 225 can facilitate formation of the body 205 from the body blank 203.

In some embodiments, the body blank 203 can be comprised of one or more paperboard materials made predominantly from cellulose fibers or paper fibers. The material may be provided in the form of a continuous web or may be provided as individual sheets of material. The paperboard material may be a single ply or multi ply material and may be a laminate comprising one or more reinforcing, moisture resistant non-cellulosic layers of materials such as films and coatings, metal foil, etc. The paperboard material may be coated, printed, embossed, etc. and may comprise fillers, pigments, binders and other additives as known in the art. In some embodiments, the paperboard material can be devoid of polymeric and/or metallic materials.

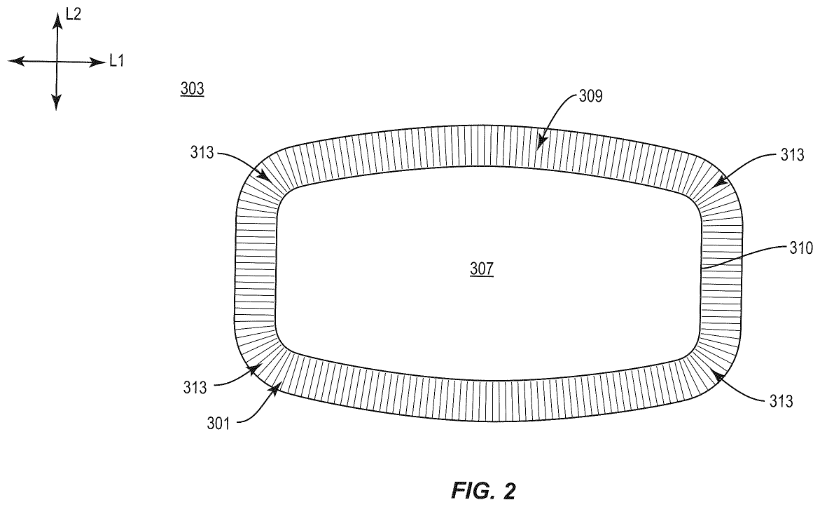

Turning to FIG. 2, the exterior surface 301 of a lid blank 303 for at least partially forming a lid 109 of the container 105 is illustrated. As shown, the lid blank 303 can have the longitudinal axis L1 and the lateral axis L2, and can include a central portion 307 and a marginal portion 309 extending to the peripheral edges of the lid blank 303.

In some embodiments, the marginal portion 309 of the lid blank 303 can be at least partially foldably connected to the central portion 307 at a generally rounded rectangular/elliptical fold line 310. In other embodiments, one or more foldable connections between the marginal portion 309 of the lid blank 303 and the central portion 307 of the lid blank 303 can be formed upon formation of the lid 109 of the container 105, as described further herein.

As also shown, the lid blank 303 can include multiple pluralities of oblique and/or curved lines of weakening 313 arranged along corner portions of the lid blank 303. As described further herein, the lines of weakening 313 can facilitate formation of the lid 109/container 105.

It will be understood that the lid blank 303 can be formed from one or more materials that are the same or similar to those that form the body blank 203 as described above, e.g., paperboard materials.

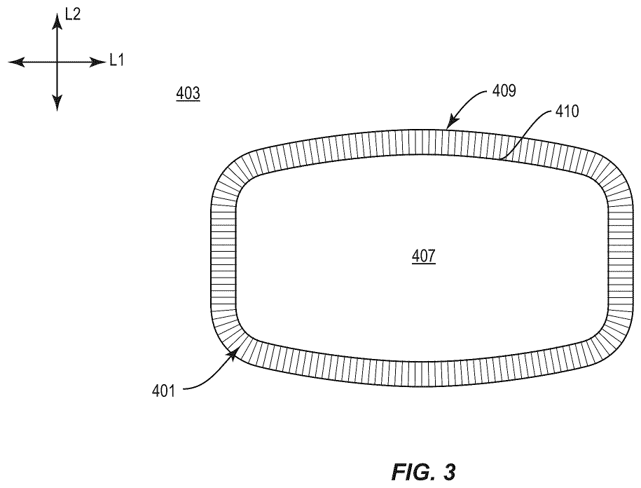

Turning to FIG. 3, the exterior surface 401 of a bottom blank 403 for at least partially forming a closed bottom or closed end 111 of the container 105 is illustrated.

As shown, the bottom blank 403 can have a configuration generally similar to that of the lid blank 303 described above, e.g., having the longitudinal axis L1 and the lateral axis L2, a central portion 407, and a marginal portion 409 extending to the peripheral edges of the bottom blank 403. In the illustrated embodiment, the marginal portion 409 can be at least partially foldably connected to the central portion 407 at a generally rounded rectangular/elliptical fold line 410, though the blank 403 can be devoid of the fold line 410 without departing from the disclosure.

In some embodiments, the bottom blank 403 can include multiple pluralities of oblique and/or curved lines of weakening arranged along corner portions of the bottom blank 403 to facilitate formation of the closed bottom 111/container 105.

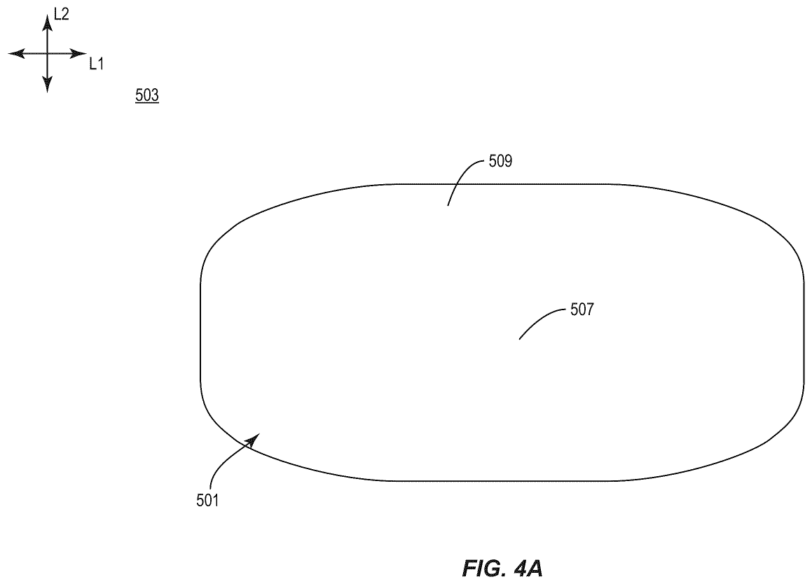

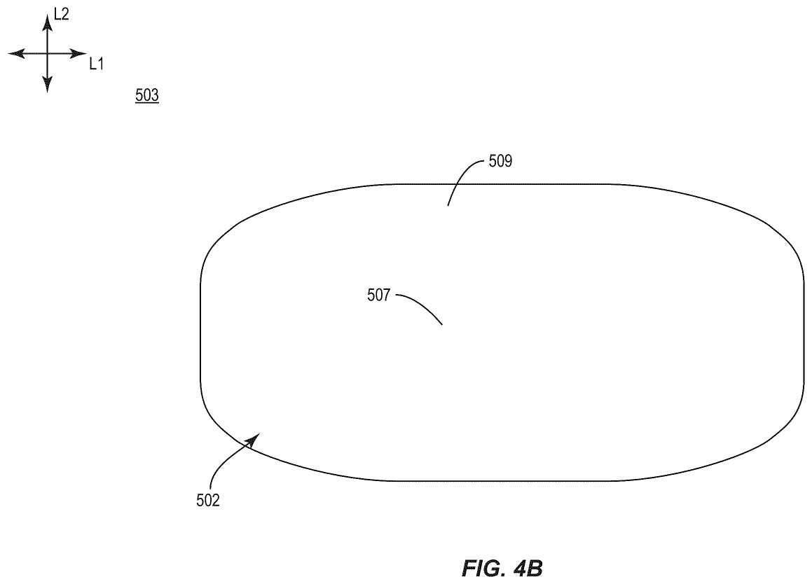

Turning to FIG. 4A, the exterior surface 501 of a barrier blank 503 for forming a barrier member 505 of the container 105 is illustrated. FIG. 4B is a plan view of the interior surface 502 of the barrier blank 503 and barrier member 505 formed therefrom.

The barrier blank 503 can have the longitudinal axis L1 and the lateral axis L2, and can include a central portion 507 and a marginal portion 509 extending to the peripheral edges of the barrier blank 503. In some embodiments, the marginal portion 509 of the barrier blank 503 can be at least partially foldably connected to the central portion 507 at one or more lines of weakening, e.g., fold lines. In other embodiments, one or more foldable connections between the marginal portion 509 of the blank 503 and the central portion 507 of the blank 503 can be formed upon formation of the barrier member 505.

In some embodiments, the barrier blank 503 and/or the barrier member 505 formed therefrom can have an area of about 143.6 cm².

The marginal portion 509 of the blank 503 can be at least partially separable from the central portion 507 of the blank 503 and barrier member 505 formed therefrom at least one line of weakening, as described further herein.

In the illustrated embodiment, the barrier blank 503 and barrier member 505 formed therefrom can be formed from a laminate structure that includes a plurality of layers in general registration, with vertically adjacent layers in overlapping and/or at least partial face-to-face contact with one another.

As described herein the laminate structure can include at least an upper portion, and, in some embodiments, a lower portion coupled to the upper portion. In some embodiments, the upper portion can be a laminate of multiple layers that forms a top web, and in some embodiments, the lower portion can include at least one layer that forms a base web.

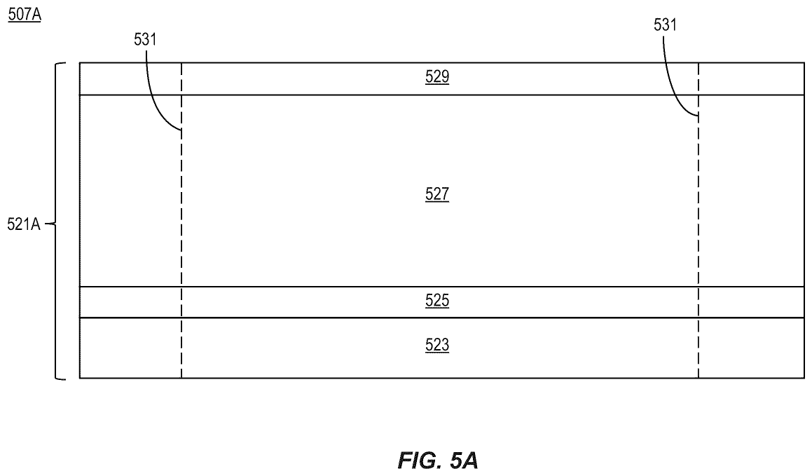

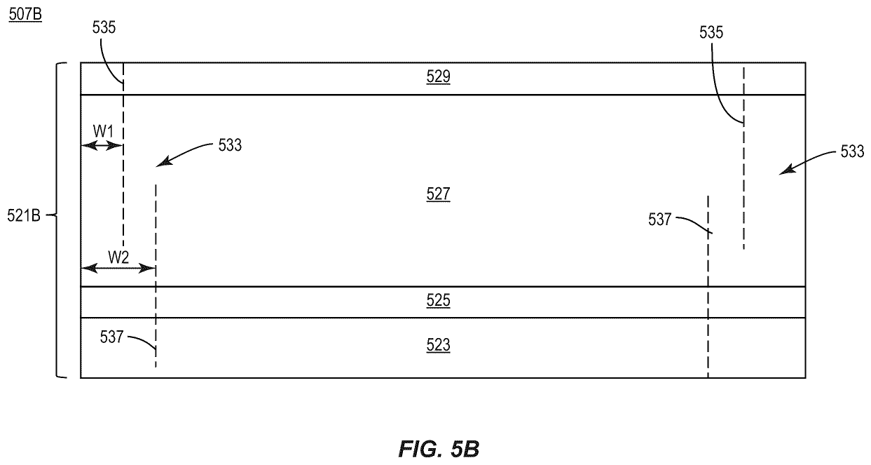

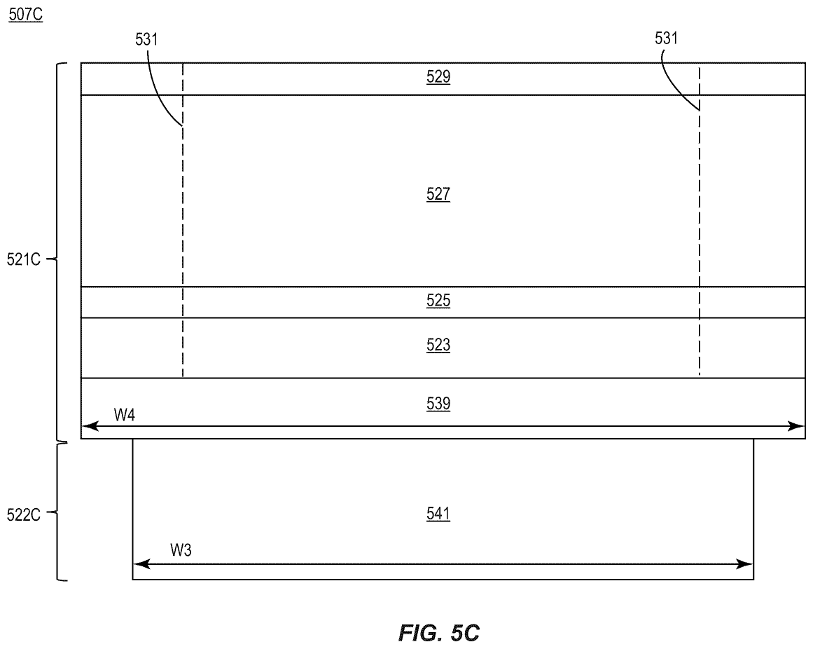

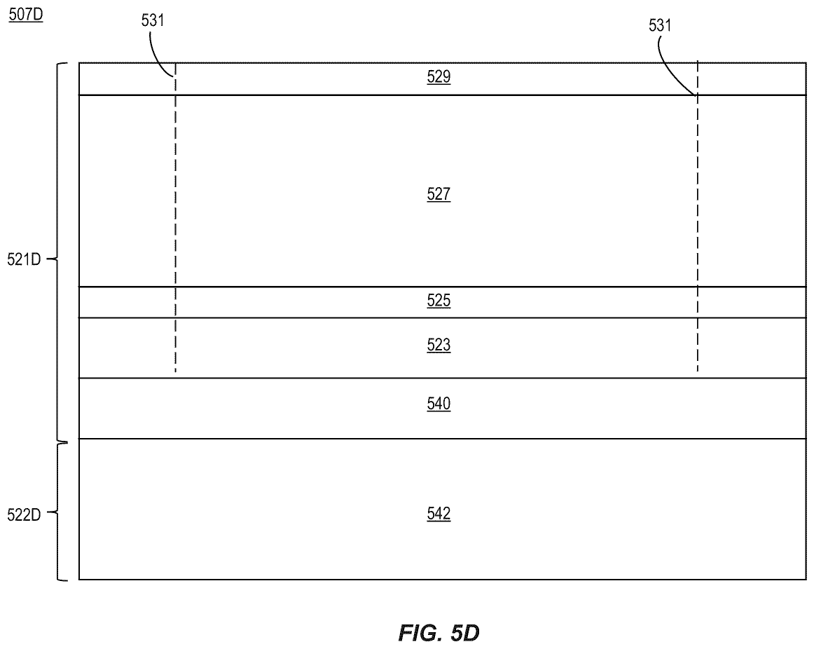

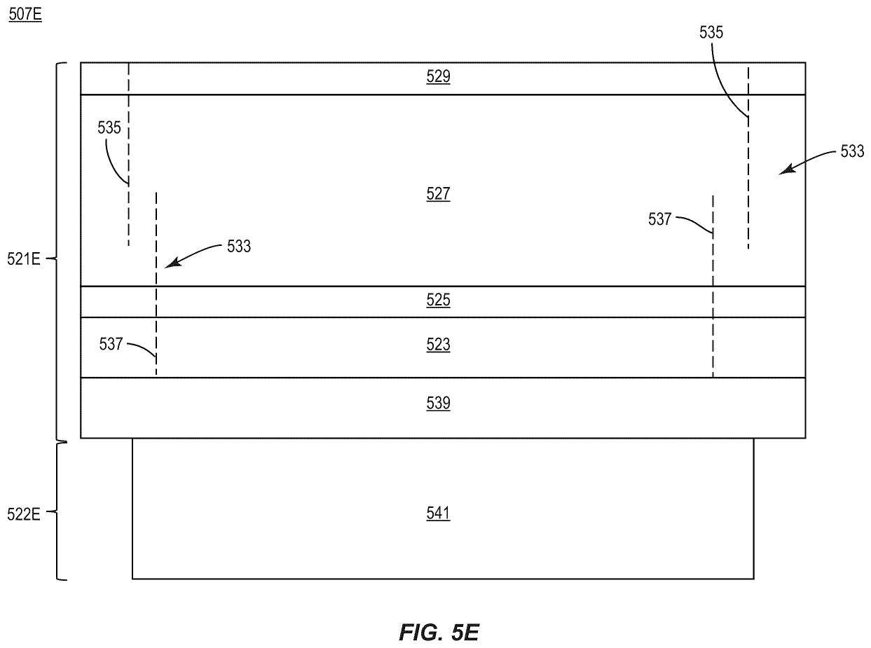

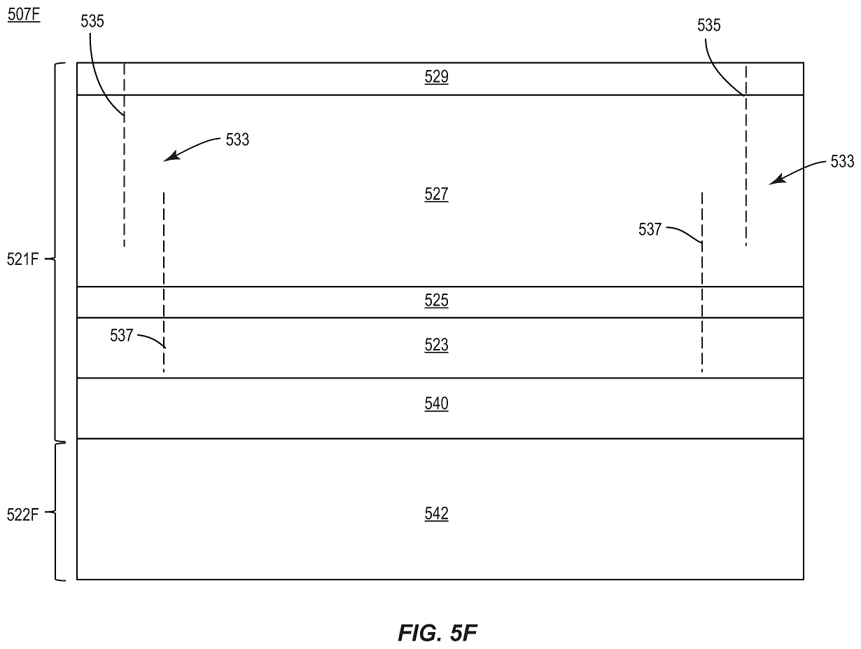

As shown in FIG. 5A, in one exemplary embodiment, the barrier blank 503 and barrier member 505 formed therefrom can include a laminate structure 507A that includes an upper portion 521A having a polymeric layer 523, an adhesive layer 525 applied to, overlapping, and/or in at least partially face-to-face contact with the polymeric layer 523, and a composite layer 527 applied to, overlapping and/or in at least partial face-to-face contact with the adhesive layer 525.

In some embodiments, the polymeric layer 523 can comprise a polymer film, for example, an oriented polyethylene terephthalate (OPET) film, for example, a bi-axially oriented polyethylene terephthalate (BOPET) film. The polymeric layer 523 can be provided in a thickness of about 12 microns, though the polymeric layer 523 can have a different configuration and/or arrangement without departing from the disclosure

The adhesive layer 525 can comprise an adhesive that can be, for example, a hot melt adhesive, a high tack glue, an epoxy, a polymeric cement, etc., or combinations thereof. It will be understood that the adhesive layer 525 can be cured, dried, or otherwise treated to provide desirable properties in the course of formation of the laminate structure 507A. In some embodiments, the adhesive layer 525 can be provided in a density of about 3 grams per square meter (gsm), though it will be understood that the adhesive layer 525 can have a different configuration or arrangement without departing from the disclosure.

In some embodiments, the composite layer 527 can comprise a paper or paperboard product such as kraft paper, parchment, clay-coated paperboard, solid bleached board (SBB) paperboard, solid bleached sulphate (SBS) paperboard, Kraft line paperboard, cardboard, or another suitable material that may be degradable, compostable, and/or repulpable.

Optionally, the laminate structure 507A can include a graphics layer 529 applied to, overlapping, and/or in at least partial face-to-face contact with the composite layer 527. In some embodiments, the graphics layer 529 can include one or more inks, printed materials, etc. In some embodiments, such printed materials can be provided along with one or more suitable coatings to facilitate clear and stable receipt thereof on the laminate structure 507A.

As also shown, the laminate structure 507A can include a line of weakening 531 that is formed by a die cut at least partially therethrough. The line of weakening 531 can be at least partially formed along a portion of the blank 503 and barrier member 505 formed therefrom, for example, a marginal portion thereof, to facilitate relative separation of portions of the barrier member 505 in the course of opening the container 105. The line of weakening 531 can be arranged to form one or more selected features, for example, an access tab, pull tab, etc. While the line of weakening 531 is illustrated as being generally continuous along respective portions of the blank 503/barrier member 505, it will be understood that the line of weakening 531 can include one or more discontinuities without departing from the disclosure.

In the illustrated embodiment, the line of weakening 531 can be formed by a die cut that extends through the optional graphics layer 529, the upper surface of the composite layer 527, the adhesive layer 525, and partially through the polymeric layer 523 to a depth spaced above a bottom surface of the polymeric layer 523. In this regard, the line of weakening 531 can be formed by a cutting tool that is inserted to a desired depth through the blank 503/barrier member 505.

In this regard, the line of weakening 531 can provide the laminate structure 507A with a polymeric layer 523 that is at least partially uninterrupted along a lower portion thereof, for example, to provide desirable fluid barrier properties, for strength and/or to provide a preselected resistance to case of tearing, etc.

Turning to FIG. 5B, a laminate structure 507B for forming the blank 503 and barrier member 505 formed therefrom is illustrated according to an alternative exemplary embodiment of the disclosure.

As shown, the laminate structure 507B can include an upper portion 521B having a configuration generally similar to that of the upper portion 521A of the laminate structure 507A, e.g., so as to include the polymeric layer 523, the adhesive layer 525, the composite layer 527, and, optionally, the graphics layer 529.

However, and as shown, the laminate structure 507B can include a line of weakening 533 that is formed by one or more die cuts at least partially therethrough. The line of weakening 533 can be at least partially formed along a portion of the blank 503 and barrier member 505 formed therefrom, for example, a marginal portion thereof, to facilitate relative separation of portions of the barrier member 505 in the course of opening the container 105. The line of weakening 533 can be arranged to form one or more selected features, for example, an access tab, pull tab, etc.

In the illustrated embodiment, the line of weakening 533 can be formed by at least two separate die cuts so as to include an upper portion 535 (broadly, “first line of weakening”) that extends through the optional graphics layer 529 and at least partially through the upper surface of composite layer 527, and a lower portion 537 (broadly, “second line of weakening”) that extends upwardly through the polymeric layer 523, the adhesive layer 525, and partially through the composite layer 527. In this regard, the upper portion 535 of the line of weakening 533 can be at least partially formed by at least one die cut through an upper surface of the laminate structure 507B, and the lower portion 537 can be at least partially formed by at least one die cut through a lower surface of the laminate structure 507B.

As shown, the upper portion 535 of the line of weakening 533 can be formed at a width W1 from an outer edge of the laminate structure 507B, and the lower portion 537 of the line of weakening 533 can be formed at a width W2 from an outer edge of the laminate structure 507B, the width W2 greater than the width W1 such that the upper portion 535 and the lower portion 537 of the line of weakening 533 can be offset from one another.

Turning to FIG. 5C, a laminate structure 507C for forming the blank 503 and barrier member 505 formed therefrom is illustrated according to another alternative exemplary embodiment of the disclosure.

As shown, the laminate structure 507C can include an upper portion 521C having a configuration generally similar to that of the upper portion 521A of the laminate structure 507A, e.g., so as to include the polymeric layer 523, the adhesive layer 525, the composite layer 527, and, optionally, the graphics layer 529. However, the upper portion 521C can additionally include a second polymeric layer 539 applied to, overlapping, and/or in at least partial face-to-face contact with the polymeric layer 523 (broadly, “first polymeric layer”).

In some embodiments, the polymeric layer 539 comprises polyethylene, though the polymeric layer 539 can have a different composition without departing from the disclosure. In some embodiments, the polymeric layer 539 can be comprised of polyethylene that can be activated, e.g., so as to cause excitement of one or more molecules thereof to facilitate scaling to the body blank 203/body 205 formed therefrom, via the application of radiofrequency energy.

Such application of RF energy can include the application of electromagnetic waves in the range of about 10 GHz to about 300 GHz. In some embodiments, the barrier blank 503/barrier member 505 can be subject to electromagnetic waves in the range of about 10 MHz and about 50 MHz. In some embodiments, electromatic waves in the range of about 20 MHz to about 30 MHz can be applied to the barrier blank 503/barrier member 505.

Such application of RF energy to the barrier blank 503/barrier member 505 can cause dipoles in the polymeric layer 539 to realign in the presence of an alternative electric field, inducing molecular rotation and subsequent intermolecular friction to generate heat in the first polymeric layer 523 to facilitate sealing the barrier blank 503/barrier member 505 to the body blank 203/body 205 formed therefrom and/or to other portions of the barrier blank 503/barrier member 505.

In this regard, RF energy can be applied to the laminate structure 507C to cause the polymeric layer 539 to heat, soften, melt, etc., so as to have adhesive properties that join the layers of the laminate structure 507C. In some embodiments, such heating of the polymeric layer 539 promotes joining of the polymeric layer 539 the remainder of the laminate structure 507C so as to form a sealing film or barrier thereon.

In some embodiments, such RF energy can be supplied by a tool or system such as that described in U.S. patent application Ser. No. 18/386,287, filed on Nov. 2, 2023, entitled Laminate Construct, Blanks And Containers Formed Therefrom, Sealing Apparatus Therefor, And Associated Methods, the entire contents of which are incorporated by reference herein as if set forth in its entirety.

In some embodiments, the polymeric layer 539 can be provided with a density of about 15 gsm, though it will be understood that the polymeric layer 539 can have a different configuration and/or arrangement without departing from the disclosure.

The laminate structure 507C can further include a lower portion 522C that includes a third polymeric layer 541 with desirable barrier properties, for example, a suitable resistance to tearing and/or to the migration of fluid particles thereacross. In some embodiments, the polymeric layer 541 can comprise an ethylene-vinyl alcohol copolymer (EVOH) having a thickness of about 40 microns, though it will be understood that the polymeric layer 541 can have a different configuration and/or arrangement without departing from the disclosure.

In the illustrated embodiment, the polymeric layer 541 can have a width W3 that is generally less than a width W4 of the upper portion 521C of the laminate structure 507C. In some embodiments, the difference between the widths W3, W4 can correspond to a marginal portion of the upper portion 521C that may be, for example, upturned or downturned for attachment to the blank 203/body 205 in the course of the formation of the barrier member 505 from the blank 503. Accordingly, the polymeric layer 541 can be dimensioned and configured so as to avoid manipulation pursuant to attachment to a remainder of the container 105, for example, to avoid weakening and/or interruption of a profile thereof.

As shown, the line of weakening 531 is provided such that no portion thereof extends into at least the polymeric layer 541, for example, to provide a lower portion of the laminate structure 507C/lower surface of the polymeric layer 539 that has an uninterrupted barrier structure that provides superior barrier properties relative, for example, to barrier structures that include such lines of weakening.

Turning to FIG. 5D, a laminate structure 507D for forming the blank 503 and barrier member 505 formed therefrom is illustrated according to another exemplary embodiment of the disclosure.

As shown, the laminate structure 507D can include an upper portion 521D having a configuration generally similar to that of the upper portion 521A of the laminate structure 507A, e.g., so as to include the polymeric layer 523, the adhesive layer 525, the composite layer 527, and, optionally, the graphics layer 529. However, the upper portion 521D can additionally include a polymeric layer 540 (broadly, “second polymeric layer”) applied to, overlapping, and/or in at least partial face-to-face contact with the polymeric layer 523.

In some embodiments, the polymeric layer 540 comprises polyethylene, though the polymeric layer 540 can have a different composition without departing from the disclosure. In some embodiments, the polymeric layer 540 can be provided with a density of about 15 gsm, though it will be understood that the polymeric layer 540 can have a different configuration and/or arrangement without departing from the disclosure.

The laminate structure 507D can further include a lower portion 522D that includes a third polymeric layer 542 with desirable barrier properties, for example, a suitable resistance to tearing and/or to the migration of fluid particles thereacross. In some embodiments, the polymeric layer 542 can comprise an ethylene-vinyl alcohol copolymer (EVOH) having a thickness of about 40 microns, though it will be understood that the polymeric layer 542 can have a different configuration and/or arrangement without departing from the disclosure.

The polymeric layer 542 can be configured for activation/sealing via the application of RF energy in the manner described above with respective to the polymeric layer 539.

In the illustrated embodiment, the polymeric layer 542 can have a width that is generally the same as the upper portion 521D of the laminate structure 507D.

As also shown, the line of weakening 531 is provided such that no portion thereof extends into at least the polymeric layer 542, for example, to provide the laminate structure 507D/polymeric layer 539 with a lower portion having an uninterrupted barrier structure that provides superior barrier properties relative, for example, to barrier structures that include such lines of weakening.

Turning to FIG. 5E, a laminate structure 507E for forming the blank 503 and barrier member 505 formed therefrom is illustrated according to another exemplary embodiment of the disclosure.

As shown, the laminate structure 507E can include an upper portion 521E having a configuration generally similar to that of the upper portion 521C of the laminate structure 507C, e.g., so as to include the polymeric layers 523, 539, the adhesive layer 525, the composite layer 527, and, optionally, the graphics layer 529.

The laminate structure 507E can also include a lower portion 522E having the polymeric layer 541.

However, and as shown, the upper portion 521E of the laminate structure 507E can include the line of weakening 533.

Turning to FIG. 5F, a laminate structure 507F for forming the blank 503 and barrier member 505 formed therefrom is illustrated according to another exemplary embodiment of the disclosure.

As shown, the laminate structure 507F can include an upper portion 521F having a configuration generally similar to that of the upper portion 521D of the laminate structure 507D, e.g., so as to include the polymeric layers 523, 540, the adhesive layer 525, the composite layer 527, and, optionally, the graphics layer 529.

The laminate structure 507F can also include a lower portion 522F having the polymeric layer 542.

However, and as shown, the upper portion 521F of the laminate structure 507F can include the line of weakening 533.

As described herein, an uninterrupted lower portion of a laminate structure can be substantially devoid of lines of weakening so as to have a generally continuous polymeric portion that can minimize, inhibit, avoid, and/or prevent the passage of fluids thereby, and can be configured to maintain such configuration in the course of manipulation incidental to placement within and/or attachment to a container 105. Such configuration can facilitate the maintenance of a sealed condition of a portion of the interior 107 of the container 105.

One or more of the blanks 203, 303, 403, 503 and one or more of the associated features thereof can have a different arrangement and/or configuration without departing from the disclosure. For example, and as described further herein, the body blank 203 can be formed into a body 205 of the container 105 with a generally rounded rectangular or elliptical vertical cross-section, with each of the blanks 303, 403, 503 having a corresponding cross-section for being at least partially received in the interior 107 of the container 105/body 205. In some embodiments, the body 205 can be formed with a different vertical cross-sectional configuration, and the blanks 303, 403, 503 can have a different configuration corresponding to such vertical cross-sectional configuration.

As described herein, the blanks 203, 303, 403, 503 can be further formed to provide components that assemble to form the container 105. In this regard, the blanks 203, 303, 403, 503 can be provided in combination for forming a system in the form of the container 105.

Turning to FIGS. 6A-6D, formation of the container 105 from the blanks 203, 303, 403, 503 will be described according to an exemplary embodiment of the disclosure.

The body blank 203 can be positioned to extend at least partially around an interior 107 of the container 105. In one embodiment, the body blank 203 can be at least partially bent, curved, folded, etc., for example, at the fold lines 223, into a generally elliptical or rounded rectangular cross-section, with portions of the body blank 203 proximate the free edges 207, 209 at least partially overlapped to form a seam arrangement, which can be maintained with a strip of adhesive tape T. In some embodiments, the free edges 207, 209 of the blank 203 can be brought into generally edge-to-edge contact.

The overlapping/meeting portions of the body blank 203 can be joined, for example, with an adhesive such as glue, with an adhesive coated tape or substrate, and/or through another method of joining such as welding, interfering locking arrangements, etc.

As shown, the body 205 of the container 105 can thus be formed, with respective portions of the body forming portion 215 of the blank 203 forming a front wall or front panel 223, a first side wall or first side panel 225, a second side wall or second side panel 227, and a back wall or back panel 229. Respective curved corners 231, 233, 235, 237 can be formed between the respective panels 223, 225, the respective panels 223, 227, the respective panels 225, 229, and the respective panels 227, 229. In some embodiments, the blank 203 can be provided with one or more lines of weakening for facilitating such formation of rounded or curved corners of the body 205.

As described above, in some embodiments, the body 205 of the container 105 can be formed into a different cross-sectional configuration, e.g., circular, elliptical, triangular, rectangular, square, pentagonal, hexagonal, heptagonal, octagonal, etc., including rounded or curved corner variations thereof.

With continued reference to FIGS. 6A-6D, the closed bottom 111 of the container 105 can be formed, according to the illustrated embodiment, by positioning the bottom blank 403 in the interior 107 of the container 105, with the central portion 407 of the bottom blank 403 positioned in generally perpendicular relation with the panels 223, 225, 227, 229 so as to form a bottom panel 411 of the container 105. As shown, the bottom blank 403 can be positioned a vertical distance above the longitudinal free edge 213 of the blank 203.

The marginal portion 409 of the bottom blank 403 can be bent or folded downwardly relative to the central portion 407 of the blank 403/bottom panel 411, for example, at the fold line 410, and attached, e.g., adhered with an adhesive such as glue, welded, or otherwise attached, to the interior surface of one or more of the panels 223, 225, 227, 229 and corners 231, 233, 235, 237 of the body 205 of the container 105.

Simultaneously or thereafter, the bottom forming portion 219 of the blank 203 can be bent/curled or folded, for example, at the fold lines 225, over the marginal portion 409 of the bottom blank 403 to form a bottom flange 113 of the container 105 that extends downwardly from the bottom panel 411. In some embodiments, the bottom forming portion 219 of the blank 203 can be crimped in such an arrangement. The bottom flange 113 can define a bottom edge of the container 105.

With continued reference to FIGS. 6A-6D, the container 105 having the closed bottom 111 can be positioned, e.g., with the bottom flange 113 extending downwardly, supported on a surface such as a conveyor for being positioned below a filling station within which one or more articles can be deposited and held in the interior 107 of the container 105. In some embodiments, a container 105 can be supported in a generally stationary position and one or more filling devices can be brought into proximity with the container 105 for depositing articles in the interior 107 of the container 105.

Articles can be inserted into the interior 107 of the container 105 upon formation of the bottom 111 thereof, or the bottom 111 can be formed after articles are positioned in the interior 107 of the container 105 in an inverted orientation, as described further below. In this regard, one or more top portions of the container 105 can be closed prior to formation of the closed bottom 111 of the container 105 such that the interior 107 of the container 105 can be filled with the container 105 in an inverted orientation, e.g., prior to formation of the closed bottom 111. As described herein, articles can be flowable products or materials, e.g., granular materials/materials with a relatively small particle size, such as flowable food products, though the articles can be other products without departing from the disclosure.

After filling the interior 107 of the container 105 with articles, the barrier blank 503 can be positioned in the interior 107 of the container 105 above the articles, with the central portion 507 of the barrier blank 503 positioned in generally perpendicular relation with the panels 223, 225, 227, 229. As shown, the barrier blank 503 can be positioned a vertical distance below the longitudinal free edge 211 of the blank 203/body 205.

In some embodiments, the barrier blank 503 can be inserted into the interior 107 of the container 105, formed into the barrier member 505, and/or attached to the body 205 of the container 105 via contact with a plunger or other moveable tool for positioning the blank 503/member 505.

In this regard, at least a portion of the marginal portion 509 of the blank 503/barrier member 505 can be bent or folded upwardly relative to the central portion 507 of the barrier blank 503 and attached, e.g., adhered with an adhesive such as glue, welded, or otherwise attached, to the interior surface of one or more of the panels 223, 225, 227, 229 and corners 231, 233, 235, 237 of the body 205 of the container 105 to form the barrier member 505.

Following formation and positioning of the barrier member 505, the lid blank 303 can be positioned in the interior 107 of the container 105 above the barrier member 505. As shown, the lid blank 303 can be positioned a vertical distance below the longitudinal free edge 211.

The central portion 307 of the lid blank 303 can be positioned in generally perpendicular relation with the panels 223, 225, 227, 229 so as to form a lid panel 311 of the container 105.

The marginal portion 309 of the lid blank 303 can be bent or folded downwardly relative to the central portion 307 of the blank 303/lid panel 311, for example, at the fold line 310, and attached, e.g., adhered with an adhesive such as glue, welded, or otherwise attached, to the interior surface of one or more of the panels 223, 225, 227, 229 and corners 231, 233, 235, 237 of the body 205 of the container 105. It will be understood that the lines of weakening 313 can facilitate positioning of the marginal portion 309 relative to corners 231, 233, 235, 237.

Simultaneously or thereafter, the lid forming portion 217 of the blank 203 can be bent/curled or folded, for example, at the fold lines 225, over the marginal portion 309 of the lid blank 303 to form a lid collar or lid flange 119 of the lid 109 of the container 105. In some embodiments, the lid forming portion 217 of the blank 203 can be crimped in such an arrangement. The lid flange 119 can define a top edge of the lid 109/container 105.

It will be understood that the container 105 can be formed in a different manner without departing from the disclosure. For example, in embodiments in which the articles are to be loaded into the interior 107 of the container 105 in an inverted arrangement, the body 205 of the container 105 can be formed and one or more of the barrier member 505 and the lid panel 311/lid 109 can be formed and attached to the body 205 before the container 105 is inverted and loaded with articles, for example, at a loading or filling station. The bottom panel 411 can then be formed and attached to the body 205 of the container 105 as described above.

In order to access the interior 107 of the container 105, a user can separate the lid 109 from the body 205 of the container 105 along tear line segments of the line of weakening 221 and hingably/foldably move the lid 109 about a fold line segment of the line of weakening 221 to allow the lid 109 to be arranged in an open position, in which the lid 109 is moved away from the interior 107 of the container 105, and a closed position, in which the lid 109 at least partially overlies and/or is at least partially received in the interior 107 of the container 105. In this regard, the lid panel 311/lid 109 can provide a selectively closed and/or reclosable top of the container 105.

When the lid 109 is in an open position, a user can remove the barrier member 505 to access articles held therebeneath. In one embodiment, the user can press the barrier member 505 at an access feature or other selected region to cause at least partial separation of the central portion 507 from the marginal portion 509 of the barrier member 505 respective lines of weakening.

Upon at least partial separation of the central portion 507 of the barrier member 505 a described above, a user can insert on or more of his or her fingers into the interior 107 of the container 105 below the barrier member 505 to engage the interior surface 502 of the barrier member 505 and pull the central portion 507 thereof upwardly to cause separation of the central portion 507 from the remainder of the marginal portion 509 along respective lines of weakening.

In this regard, upon pushing or pulling by a user on the barrier member 505, one or more lines of weakening can be caused to propagate further therealong to facilitate separation of the central portion 507 from the marginal portion 509 of the barrier member 505.

Due to the configuration of the barrier member 505 and the laminate structures that form the blank 503/barrier member 505, e.g., the uninterrupted lower portion of the laminate structure that forms the blank 503/barrier member 505, the blank 503/barrier member 505 can provide superior barrier properties to maintain one or more conditions of articles in the interior 107 of the container 105, e.g., to maintain freshness, to maintain a sealed condition thereof, to maintain a moisture barrier, to avoid contact with debris from the environment, to prevent access by pests, etc., for example, as compared to a barrier member in which lines of weakening fully penetrate such structures. Furthermore, this arrangement of lines of weakening in the blank 503/barrier member 505 can provide superior tear resistance to incidental forces, e.g., those not intentionally applied by a user during opening, for example, during installation of the blank 503/barrier member 505 in the interior 107 of the container 105, during storage and/or transport, pressure changes, etc.

Furthermore, the arrangement of the lines of weakening extending at least partially through the blank 503/barrier member 505 can maintain the integrity, e.g., sealing capability of the laminate structure thereof when attached to the body 205 of the container 105, incidental to the action of a plunger tool, sealing tool, or other machine component for positioning and/or attaching the blank 503/barrier member 505 relative to the remainder of the container 105.

It will be understood that the container 105 and/or one or more components thereof can have a different configuration without departing from the disclosure. For example, it will be understood that one or more of the blanks and members described herein can be shaped, sized, or otherwise configured to engage such container structures. Such container structures can include Boardio®, available from Graphic Packaging International, LLC of Atlanta, GA, Sealio®, available from Graphic Packaging International, LLC of Atlanta, GA, and Cekacan®, available from Graphic Packaging International, LLC of Atlanta, GA, to name a few.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the containers to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure container panels or portions in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A container for holding at least one article, the container comprising:
a body extending at least partially around an interior of the container, a closed top engaged with the body;
a closed bottom engaged with the body; and
a barrier member positioned in the interior of the container, the barrier member comprising a laminate structure that includes at least one polymeric layer with an uninterrupted lower portion.

2. The container of claim 1, wherein the uninterrupted lower portion is devoid of one or more lines of weakening so as to be a generally continuous portion of the at least one polymeric layer configured to avoid the passage of fluids thereby.

3. The container of claim 2, wherein the laminate structure further comprises a composite layer above the at least one polymeric layer.

4. The container of claim 3, wherein the laminate structure comprises at least one line of weakening extending partially therethrough so as to terminate above a lower surface of the at least one polymeric layer to form the uninterrupted lower portion thereof.

5. The container of claim 4, wherein the at least one polymeric layer is a second polymeric layer, the laminate structure comprises a first polymeric layer between the first polymeric layer and the composite layer, the at least one line of weakening extending at least partially through the first polymeric layer.

6. The container of claim 4, wherein the at least one line of weakening is a second line of weakening extending at least partially through the composite layer and the first polymeric layer, and the laminate structure comprises a first line of weakening extending at least partially through the composite layer, the first line of weakening spaced apart from the second line of weakening.

7. The container of claim 5, wherein the second polymeric layer comprises polyethylene.

8. The container of claim 7, wherein the second polymeric layer is configured for activation upon exposure to radiofrequency energy for facilitating sealing of the barrier member to the body of the container.

9. The container of claim 7, wherein the second polymeric layer has a density of about 15 gsm.

10. The container of claim 7, wherein first polymeric layer comprises an oriented polyethylene terephthalate (OPET) film.

11. The container of claim 10, wherein the OPET film is a bi-axially oriented polyethylene terephthalate (BOPET) film.

12. The container of claim 11, wherein the first polymeric layer has a thickness of about 12 microns.

13. The container of claim 12, wherein the composite layer, the first polymeric layer, and the second polymeric layer at least partially form an upper portion of the laminate structure, wherein the laminate structure further comprises a lower portion contacting the upper portion thereof, and wherein the lower portion of the laminate structure comprises a third polymeric layer contacting the second polymeric layer.

14. The container of claim 13, wherein the third polymeric layer comprises an ethylene-vinyl alcohol (EVOH) copolymer.

15. The container of claim 14, wherein the third polymeric layer has a thickness of about 40 microns.

16. The container of claim 14, wherein the third polymeric layer has a width that is less than a width of the upper portion of the laminate structure.

17. A combination of blanks for forming a container for holding at least one article, the combination of blanks comprising:
a body blank for forming a body of the container formed from the combination of blanks;
a bottom blank for being engaged with the body of the container formed form the combination of blanks to form a closed bottom;
a lid blank for engaging the body of the container formed from the combination of blanks to form a closed top; and
a barrier blank for forming a barrier member of the container formed from the combination of blanks, the barrier blank comprising a laminate structure that includes at least one polymeric layer with an uninterrupted lower portion.

18. The combination of blanks of claim 17, wherein the uninterrupted lower portion is devoid of one or more lines of weakening so as to be a generally continuous portion of the at least one polymeric layer configured to avoid the passage of fluids thereby.

19. The combination of blanks of claim 18, wherein the laminate structure further comprises a composite layer above the at least one polymeric layer.

20. The combination of blanks of claim 19, wherein the laminate structure comprises at least one line of weakening extending partially therethrough so as to terminate above a lower surface of the at least one polymeric layer to form the uninterrupted lower portion thereof.

21. The combination of blanks of claim 20, wherein the at least one polymeric layer is a second polymeric layer, the laminate structure comprises a first polymeric layer between the first polymeric layer and the composite layer, the at least one line of weakening extending at least partially through the first polymeric layer.

22. The combination of blanks of claim 20, wherein the at least one line of weakening is a second line of weakening extending at least partially through the composite layer and the first polymeric layer, and the laminate structure comprises a first line of weakening extending at least partially through the composite layer, the first line of weakening spaced apart from the second line of weakening.

23. The combination of blanks of claim 21, wherein the second polymeric layer comprises polyethylene.

24. The combination of blanks of claim 23, wherein the second polymeric layer is configured for activation upon exposure to radiofrequency energy for facilitating sealing of the barrier member to the body of the container.

25. The combination of blanks of claim 23, wherein the second polymeric layer has a density of about 15 gsm.

26. The combination of blanks of claim 23, wherein first polymeric layer comprises an oriented polyethylene terephthalate (OPET) film.

27. The combination of blanks of claim 26, wherein the OPET film is a bi-axially oriented polyethylene terephthalate (BOPET) film.

28. The combination of blanks of claim 27, wherein the first polymeric layer has a thickness of about 12 microns.

29. The combination of blanks of claim 28, wherein the composite layer, the first polymeric layer, and the second polymeric layer at least partially form an upper portion of the laminate structure, wherein the laminate structure further comprises a lower portion contacting the upper portion thereof, and wherein the lower portion of the laminate structure comprises a third polymeric layer contacting the second polymeric layer.

30. The combination of blanks of claim 29, wherein the third polymeric layer comprises an ethylene-vinyl alcohol (EVOH) copolymer.

31. The combination of blanks of claim 30, wherein the third polymeric layer has a thickness of about 40 microns.

32. The combination of blanks of claim 30, wherein the third polymeric layer has a width that is less than a width of the upper portion of the laminate structure.

33. A method of forming a container for holding at least one article, the method comprising:
obtaining a body blank;
obtaining a bottom blank;
obtaining a lid blank;
obtaining a barrier blank, the barrier blank comprising a laminate structure that includes at least one polymeric layer with an uninterrupted lower portion;
positioning the body blank to form a body extending at least partially around an interior of the container;
engaging the bottom blank with the body of the container to form a closed bottom of the container;
engaging the barrier blank with the body of the container to form a barrier member in the container; and
engaging the lid blank with the body of the container to form a closed top of the container.

34. The method of claim 33, wherein the uninterrupted lower portion is devoid of one or more lines of weakening so as to be a generally continuous portion of the at least one polymeric layer configured to avoid the passage of fluids thereby.

35. The method of claim 34, wherein the laminate structure further comprises a composite layer above the at least one polymeric layer.

36. The method of claim 35, wherein the laminate structure comprises at least one line of weakening extending partially therethrough so as to terminate above a lower surface of the at least one polymeric layer to form the uninterrupted lower portion thereof.

37. The method of claim 36, wherein the at least one polymeric layer is a second polymeric layer, the laminate structure comprises a first polymeric layer between the first polymeric layer and the composite layer, the at least one line of weakening extending at least partially through the first polymeric layer.

38. The method of claim 36, wherein the at least one line of weakening is a second line of weakening extending at least partially through the composite layer and the first polymeric layer, and the laminate structure comprises a first line of weakening extending at least partially through the composite layer, the first line of weakening spaced apart from the second line of weakening.

39. The method of claim 37, wherein the second polymeric layer comprises polyethylene.

40. The method of claim 39, wherein the second polymeric layer is configured for activation upon exposure to radiofrequency energy for facilitating sealing of the barrier member to the body of the container.

41. The method of claim 39, wherein the second polymeric layer has a density of about 15 gsm.

42. The method of claim 39, wherein first polymeric layer comprises an oriented polyethylene terephthalate (OPET) film.

43. The method of claim 42, wherein the OPET film is a bi-axially oriented polyethylene terephthalate (BOPET) film.

44. The method of claim 43, wherein the first polymeric layer has a thickness of about 12 microns.

45. The method of claim 44, wherein the composite layer, the first polymeric layer, and the second polymeric layer at least partially form an upper portion of the laminate structure, wherein the laminate structure further comprises a lower portion contacting the upper portion thereof, and wherein the lower portion of the laminate structure comprises a third polymeric layer contacting the second polymeric layer.

46. The method of claim 45, wherein the third polymeric layer comprises an ethylene-vinyl alcohol (EVOH) copolymer.

47. The method of claim 46, wherein the third polymeric layer has a thickness of about 40 microns.

48. The method of claim 46, wherein the third polymeric layer has a width that is less than a width of the upper portion of the laminate structure.
